(19) United States
(12) Patent Application Publication
(10) Pub. No.: US 2002/0101241 A1
(43) Pub. Date: Aug. 1, 2002

(54) Internal antenna for magnetic resonance imaging, and a 'C' magnet horizontal field magnetic resonance system

(76) Inventor: Kui Ming Chui, Ickenham Uxbridge (GB)

Correspondence Address: PRO-TECHTOR INTERNATIONAL SERVICES, 20775 Norada Court, Saratoga, CA, 95070-3018, US

(21) Appl. No.: 09/773,029

(22) Filed: Jan. 30, 2001

(51) Int. Cl. G01V 3/00

(52) U.S. Cl. 324/319

(57) ABSTRACT

(A) This invention of the flexible, expandable, & retractable balloon (FERB) RF internal receiving coil is aimed at addressing the key areas of interest such as the enhancement of the MR image performance at the local areas/volume of the patient organs being studied, the provision of images beyond the tissue walls where the Endoscopy fails to provide, the designs of the shape and size of the balloon/RF coil insert to fit into the patient organs' contours and into a greater depth such as the intestines etc . . . the user friendliness and comfort, and, the meting the health and safety requirements. Whereas the existing internal RF coil designs fail to address either partly, or mostly. A rigid-rod cervix RF receiving coil and its disposable outer shell are also included into the invention., and,

(B) The invention of the ‘C’ magnet horizontal field MR system will help to overcome many of the disadvantages associated with the current two types of MR systems, and to provide enhancements while maintaining the low cost features.

### INTERNAL ANTENNA FOR MAGNETIC RESONANCE (MR) IMAGING

This invention relates to the flexible, expandable and retractable internal antennae, or radio frequency (RF) receiving coils for the Magnetic Resonance Imaging. It also includes a rigid-rod version of the cervix RF receiving coil.

### BACKGROUND OF MAGNETIC RESONANCE IMAGING (MR OR MRT)

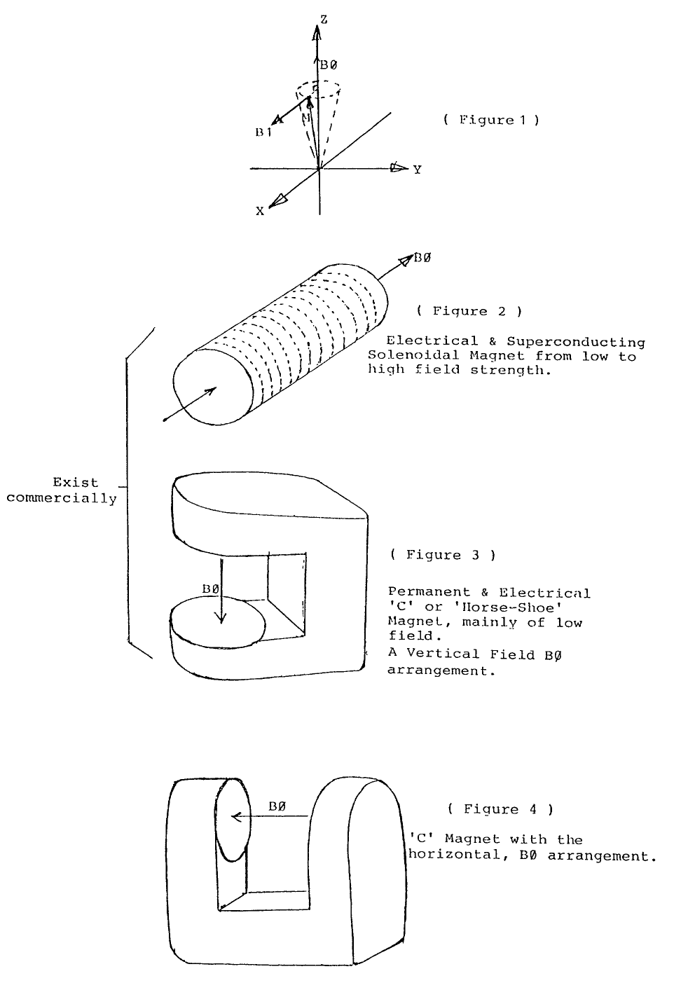

In Magnetic Resonance Imaging, the nuclear magnetic moments of protons in water and tissues will line up and process around the main magnetic field, B₀ at a frequency called the resonant Larmor processing frequency, W₀, where W₀=r B₀; r =magnetogyric ratio. or f₀=(r/2) B₀; f₀=rB₀, if r is expressed in MHz per Tesla. Energy may be input to be absorbed by the processing protons to lift the protons from the more densely populated lower energy state to a higher energy state; simply by applying another field B₁, which is also rotating at the same Larmor frequency, in perpendicular to the main B₀ field (FIG. 1). This B₁ field is also known as the radio frequency (RF) field. The angle, rotted by the B₁ is :−=B₁t, where t is the time that B₁ is switched on, B₁ t gives the RF pulse. 90 degree or 180 degree pulses are often used in MR Imaging technology. The B₁ field may be turned on or off. When switched on, the “pulse” B₁ is the field that is absorbed as energy by the proton spins. When the B1 field is switched off, the excited proton spins will tend to ‘relax’ by returning to the original low energy state. The relaxation decay of the nuclear signal intensity my be detected by a RF receiving coil (of an antenna) placed at an optimum right angle to the B₀ field.

### MAGNET TYPES

There are two major types of magnet having three different orientations of the main fields B₀. The first type is the solenoidal magnet (FIG. 2). The B0 is horizontal and along the axial direction of the solenoid windings. Both electrical and super conductive drivers exist. They cover from the low to the high field. The second type is the ‘C’ magnet or the ‘Horse-Shoe’ magnet having a vertical B₀ field (FIG. 3). Both the permanent and electrical forms of this geometry are commercially available to cover mainly the low field region of less than 0.5 tesla. The distinct advantage of MR system using this type of ‘C’ magnet is the easy patient accessibility. A third orientation of the B₀ field, i.e. a horizontal B₀ of a ‘C’ magnet may be obtained by turning the vertical field ‘C’ magnet by 90 degree (FIG. 4). As the patient's body contour is oval in shape, and is normally lying down on the back for the scans, a horizontal B₀ is more efficient for the RF coil designs of certain coils such as Surface, Saddle, or Solenoid Coils. The design of this MR system is lescribed in details in the paragraph of “A ‘C’ Magnet Horizontal Field MR System”—this is the second invention in this application.

### T1, T2 RELAXATION TIMENS AND PROTON DENSITY

Magnetic Resonance imaging depends on three characteristics of the tissue protons:

(a) the proton density (or the amount of proton presents in the sample),

(b) the Spin-Sattice (or the proton spin's interaction with its environment, the lattice) Relaxation Time, T₁. It is also called the longitudinal relaxation—it is the relaxation process by which the magnetization along the z axis (or the axis of the main magnetic field, B₀), is recovered., and ,

(c) the Spin-Spin (that is , the incremental-field interaction of one nuclear upon its neighbors and vice versa), or Transverse Relaxation. It is the relaxation process by which the xy plane decays (the xy plane is perpendicular to the z-axis, the B0 direction; and that the proton spins are excited into the xy plane by the 90 degreed RF pulse). In MR Imaging, it is necessary to superimpose three linear gradient fields onto the main magnetic field to differentiate the ‘coordinate positions’ and the ‘phase’ within the volume of a two dimensional slice or a three dimensional volume. From the Bloch equations, we may derived the equations from which scan sequences may be generate to obtain the T1-weighted, T2-weighted, proton density the equilibrium state.

The relaxation decay of the nuclear signal intensity may be detected by a RF receiving coil (or an antenna) placed at a right angle to do the B0 field. Indeed, in some cases where the same coil is used for both the transmission and the receiving of the B1 field. However, only RF receiving coils are dealt with in this invention.

### KEY AREAS OF THIS TECHNOLOGY OF INTERNAL RF COILS ARE TYING TO ADDRESS

(1) To localize the imaging—this will provide the enhanced image(s) in areas or volume adjacent to the coil so that an enlarged or magnified region of interest may be achieved.,

(2) An advantage and over the Endoscope approach in that, MR technique can penetrate through the tissue walls to provide images beyond, and it can also overcome optically obscuring substance such as blood, or fat, After a lesion on the tissue wall is detected by Endoscope, the MR using these RF receiving coils can provide images beyond the tissue walls for the monitoring of the lesion growth, and for the treatment planning and surgery etc..,

(3) Needs to be tightly fitted onto the tissue walls of the canals or passage, such as that of the rectum, interesting, vagina, stomach, or surgery opening etc.. such that the relative movement do not cause problem(s) in the MR imaging.,

(4) User friendly and patents comfort—the endoscope or catheter approach is more user friendly than the ultra-sound probe or the rigid-rod approach. The later approach is usually restricted to the entrance area not too far onto the passage or into a deep strait passage or a canal of opening such as the vagina etc. The shape, size, and hardness of the rigid rod to be inserted do matter as well

(5) Health and safety consideration—any plastic material will absorb a certain amount of moisture. Therefore a rigid rod object can not be one hundred percent sterilized. To prevent the transmittable disease such as Human Imnmunodeficiency Virus (HIV), Hepatitis B, and others, the disposable approach is much safer., and, (6) twist and turn and depth within the human organ may vary according to the different types of organ, and change from patient to patients. The flexible tubing, or the catheter approach is more adaptable, versatile, and user friendly. However due to the main coil inductance in various cases, an automatic tune and match system will be required to optimize the performance of the flexible coil assembly.

### BACKGROUND OF THE CURRENT RF INTERNAL RF RECEIVING COILS

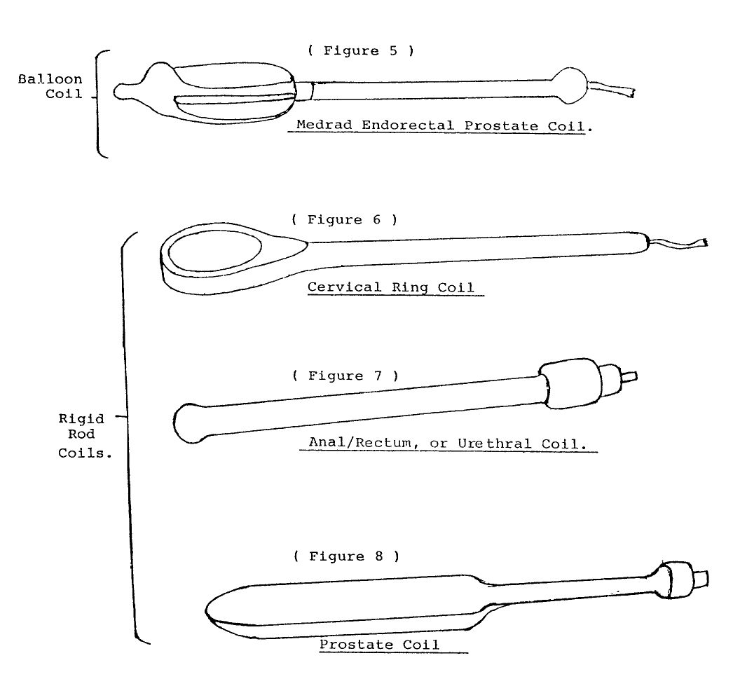

Internal RF receiving coils for MRI is still in its infancy. There is currently one type of internal coil, called the Medrad Endorectal prostate coil (FIG. 5) which is available in the market. The Medrad coil has an inflatable balloon end made to carry a RF coil within it. When inflated with air, the RF coil will pressed against the tissue walls towards the prostate gland area, and this will enable the imaging of the said area with the enhanced image quality. The tune and match of the coil are done externally via an automatic device. The above coil is attached to a rigid rod and therefore is only suitable to operate near the entrance of an orifice such as the rectum. The Medred coil is the disposable type. There are several other rigid-rod type of internal coils, namely, (a) the Cervical Ring coil (FIG. 6), which has two flat ring loops as the main coil in series or in parallel. A flat ring loop may consider as a degenerated halves of saddle coil. (b) the cylindrical Anal Coil (FIG. 7), which has two halves of saddle coil. Wrapped around a cylindrical former, and (c) Prostate Coil of cylindrical shape but with a flat surface on one side (FIG. 8). The prostate coil has either a signal rectangular flat coil loop mounted onto the flat surface, or two rectangular flat coils overlapped about 10.3 per cent of the area at each end of the two edges to optimize the combined flux through the overall volume of the assembly, that the signal to noise of the combined assemble over the signal large coil covering the same overall is improved a factor about 1.75 (ref. to “The NMR Phase Array” by P. B. Roemer et at., Magnetic Resonance in Medicine 16, 192-225 (1990)). These ridge-rod coils adopt the similar approach to the current ultra-sound probe. The above three type of coil are mainly used near the entrance of orifices such as the rectum, or not too far inside, or inside a straight muscular canal such as the vagina. The Ring Coil is mainly used for imaging the cervix. The Anal Coil is for the anal sphincter (a reduce-size version of this coil may also be used for the urethral), and the Prostate Coil is for the prostate gland area. These three types of coil are currently used in clinical researches, and have achieved some remarkable results. Similar to the ultrasound probes, these ridge-rod coils are used with latex covering (the trade name condom) over them, and may be sterilized for further re-uses. Electronically, the ridge-rod coil has a fixed main coils\inductance, and therefore the components carried on board of the rod former.

The current Internal RF Receiving fail to address some of the key area of interest mentioned above.

### THIS INVENTION

This invention aims to address more of or all of above said key areas of interest.

### MECHANICAL STRUCTURE OF THIS INVENTION

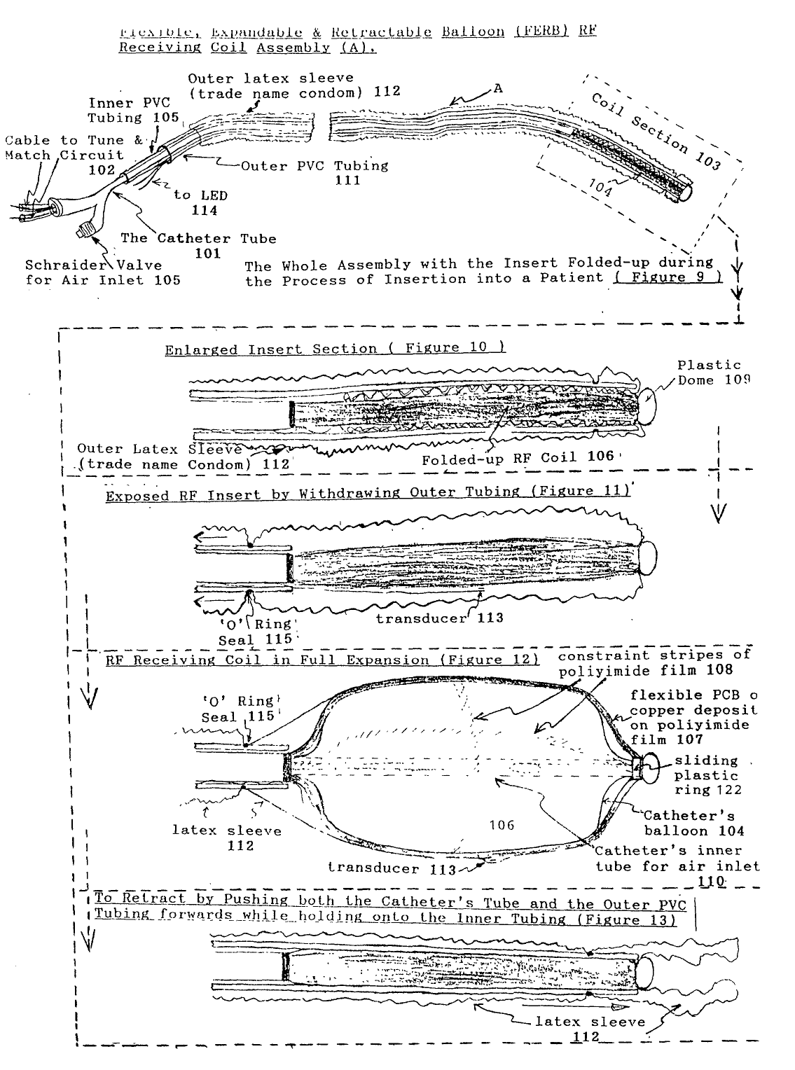

This invention is concerned with a RF internal receiving coils (or an internal antenna) called the Flexible, Expandable, & Retractable Balloon (FERB) RF Receiving Coil. A (FIG. 9). Its application is for the MR imaging via the internal insertion. The structure of the whole coil assemble may explained as follows:

With reference to FIGS.9-13, the inner-most part of the assemble is the well-know catheter tube 101 which is hollow in the center. This will allow cables 102 to be inserted and to be connected onto the main section 103 mounted onto the balloon end 104. the catheter tube is made of latex rubber and, and has a Schraider valve 105 for air inlet. The Schraider valve is the same type as that used in the ordinary car type, which may be closed by the inside pressure of the enclose. Air that is pumped through the valve will go through a tunnel to inflate the balloon 104 at the other end. In effect, the balloon is the second layer of the catheter lubing assembles. Onto the catheter tube, a flexible tube called the inner PVC (or any other suitable plastic material) tubing 105 which has an internal diameter that is slightly greater than the outside diameter of the catheter tubing 101 (FIG. 9) is mounted. At the end of this PVC tubing, there is a fold up RF coil(s) 106 (FIGS. 10 & 12). It is of a certain geometrical structure made of stripes of flexible PCB material of copper deposit in thickness of 50-150 microns onto the flexible poliyimide film 107 (in thickness of 50-75 microns). The RF coil 106 is also further constrained to a definite shape by stripes of poliyimide film 108 (or other flexible plastic film material) (FIG. 12). At the tip end of the catheter tube, the flexible PCB structure 107 and the constraint stripes 108 are attached onto a delrin/or plastic ring 122. on which, some components such as capacitors may be placed and across which two cables may be attached to be output via the inner-most hollow tubing 110 to the external tune and match circuit 102. An outer PVC tubing 111 (FIG. 9) of an appropriate length and with an internal diameter slightly larger than the outer diameter of the inner PVC tubing 105 may be placed. A latex sleeve (with the trade name condom) 112 is placed on to cover the whole RF assembly. A delrin (or other plastic material) dome 109 is placed at the very tip end of the catheter tube 101 and the RF coil section 103. This will help to anchor the RF coils assembly section 103 as well as to prevent the dome and coil assembly to be accidentally drawn too far inter PVC tubing. A transducer device(s) 113 may be placed between the flexible PCB and the latex sleeve (FIG. 12). These transducer(s) may be linked to the external Led 114 to monitor the inflation of the balloon. The latex sleeve is also anchored somewhere along the outer PVC tubing and made it water-tight by such as an ‘O’ ring seal 115. All components used above must be strictly non-magnetic. The above assembly may hence be referred to as the ‘balloon/RF coil’ insert. The whole n-vivo operation may be explained by FIGS. 9-13. After the catheter with the coil assembly have been inserted inside a patient and with the ‘RF coil section’ properly put in-place (FIG. 10), the inner PVC tubing may then be held on firmly to withdraw the outer PVC tubing in order to expose the RF coil section (FIG. 11). Air may then be pumped in through the Schraider valve to inflate the balloon until the transducer has been activated by the internal pressure built up between the balloon wall against the tissue wall. This will be indicated by the LED device externally. MR imaging may then be initiated. After the imaging has been completed, the retraction may be done by the exact reverse operation of:

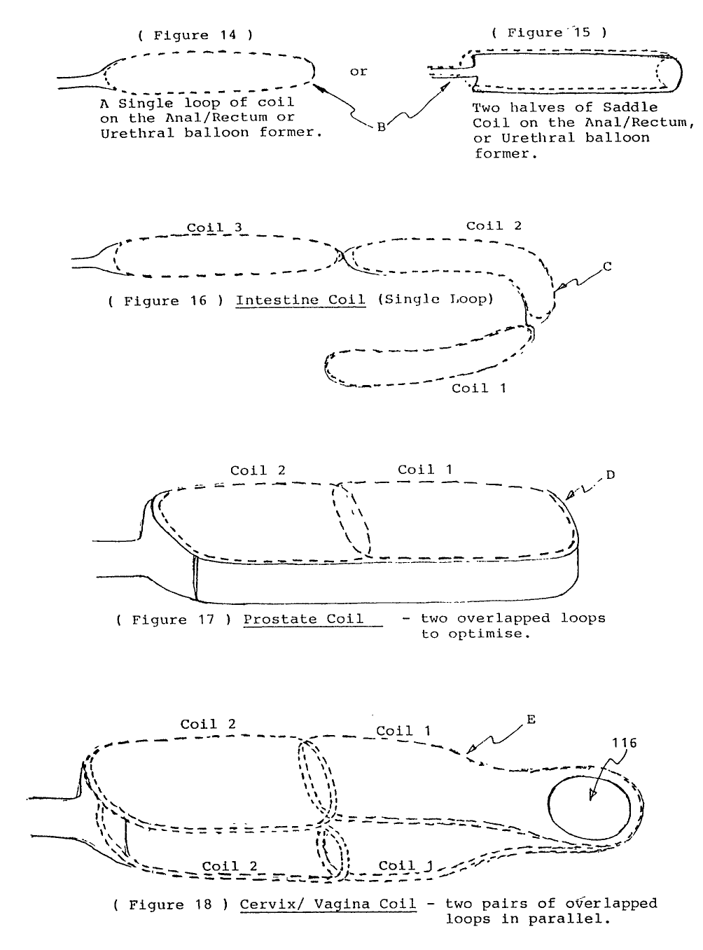

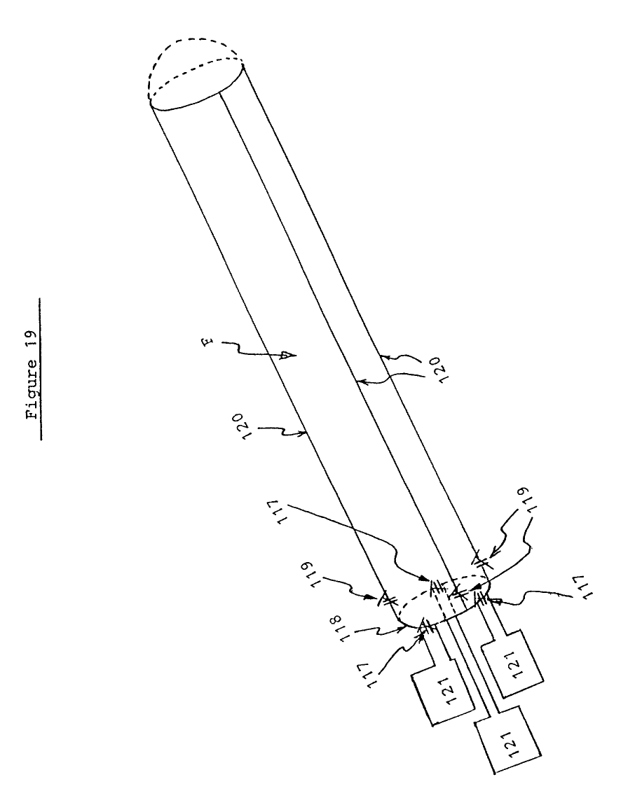

firstly, to release the air of the balloon, and then to hold onto the inner PVC tubing and push the outer PVC outer tubing back on until it touches the delrin dome. The whole assembly may then be withdrawn by pulling out the inner PVC and the catheter tubing altogether. The balloon at the end of the catheter may be of any shape or size. It may be spherical, cylindrical, rectangular, or elongated. They may be several balloons chained together. All various shapes and sizes are all within the scope of this invention. The size may be large enough to fit into the stomach or small enough to fit into the ear. Or elongated and cylindrically shaped like sausages B (FIGS. 14-15) for the rectum area, or several sections chained together like a string of sausages C to be fitted into the intestines (FIG. 16). Or it could take the elongated and rectangular shape for the prostate imaging D (FIG. 17). Or it may have the combined shape of the elongated and rectangular cylinder with a thin ring section at the far end E (FIG. 18). This will enable the ring part of the coil 116 to be hooked onto the cervix to image the cervix, the areas/volume above the cervix, and the surrounding areas/volume outside the vagina canal. The coil winding may be of a single loop(s) (FIGS. 14 and 16); Or it may have two halves of the saddle coil mounted on (FIG. 15). It may also have two coils overlapped by the optimum amount (of about 10.3%) of their areas to give the optimal combined signal-to-noise of about 75% (FIG. 17). It may also be possible to place multiple coils at the corners and overlap to provide the optimum signal-to-noise for the vagina canal's areas/volume imaging (FIG. 18). Another design F is to use three coils with shared arms 120 which are separated from each other by one hundred and twenty degrees apart as indicated in FIG. 19. This design is easy to manufacture and the “tuning” may be accomplished through the capacitors 117 on the top ring of 118 and the capacitors 119 along one end of the three arms through an iteration process. Signals from the three coil arrays are taken across the capacitors 117 and output to the separate tune and match circuits of 121. The gain in signal-to-noise using this three-coils array approach is about 67%.

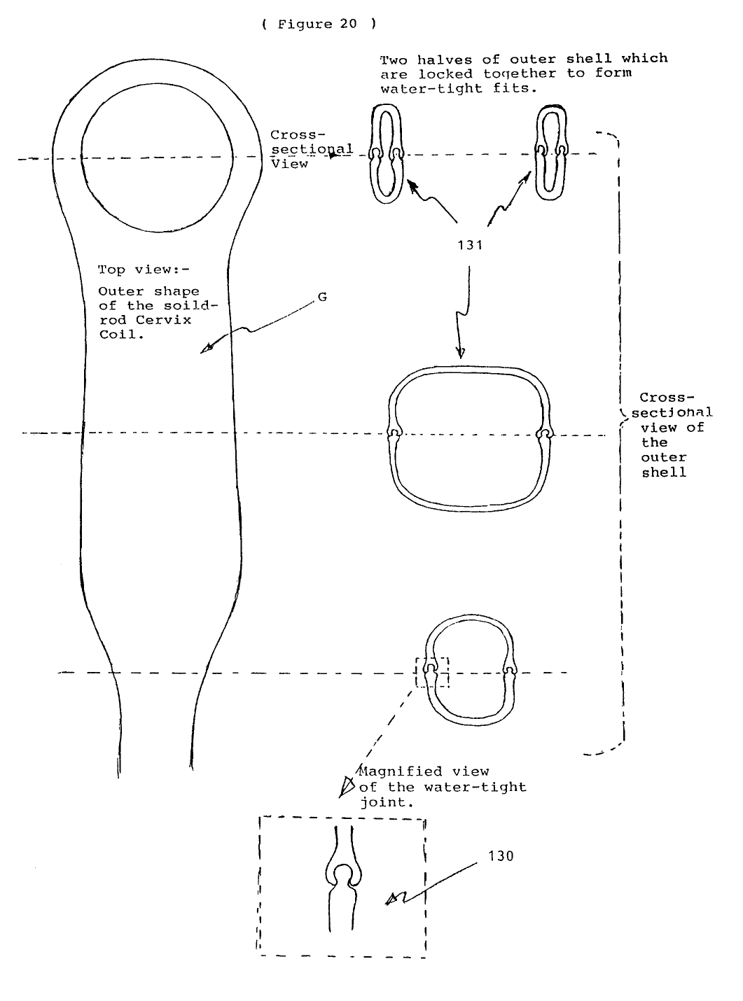

Due to the vagina canal being relatively straight and may be extended in the diameter direction, the FERB Cervix RF Receiving Coil E of FIG. 18 may be made into the rigid rod from. The coil winding(s) on the solid material former may be either the single loop of coil only, or the two pairs of coil to overlap such that the optimum MR signal is achieved. This rigid rod design will also provide MR images at the cervix, areas/volume above the cervix, and areas/volume surrounding the canal passage. In the case of this solid rod design, an outer shell G as drawn in FIG. 20 may be implemented to form a water tight seal 130. This outer shell has two halves 131 which may be readily pulled apart for the replacement. This disposable outer shell will help to meet the health and safety requirements. The design of the two halves of the outer shell are such that they may be fit into any shape and/or narrow neck regions of any solid rod former. This same design may also be adopted for the ultra-sound probes achieving the same partial disposable for the health and safety considerations.

### B1 WITH THE B0 FIELD FOR THE INTERNAL RF COILS

As explained in the introductory paragraph, the transmit and receive B₁ direction will require to be perpendicular to the main field B₀ for the optimum operation (FIG. 1). When it is at non-right angle, the cosine effect will come in. The normal direction to the coil plane of a RF coil is the optimum vector direction for that receiving coil. Therefore, for the Medrad Endorectal Prostate Coil, and the rigid-rod coils of the Cervical Ring Coil, the Anal or Urethral Coil, and the Prostate Coil, their normal vectors, and their flux return paths are lying in the xy plane which is perpendicular to the B₀ of a Solenoid Magnet System. In the case of using the FERB Coils of this invention inside the patient's organs such as the stomach. Or intestines etc. where there are twists and turns, it must be ensured that the cosine effect does not cause too much loss in the signal. If necessary, a patient may be re-scanned with the vertical field ‘C’ Magnet MR System and then turn the patient on the side or at an angle provided that the magnet's Pole Gap is wide enough. or alternatively, let the patient lies on the back, and turn the couch about the axis of the B₀ either clockwise or anti-clockwise for up to 90 degrees.

The combined operations of scanning in the Solenoid System, and the ‘C’ System at various angles may cover all three orthogonal directions of the B₀ field, and possibly, also the angles in between. These will help to cover all the ‘dark’ areas of the twist and turn of patient's organs.

### ELECTRICAL CIRCUITS-TUNE AND MATCH, AND DE-COUPTING CIRCUITS

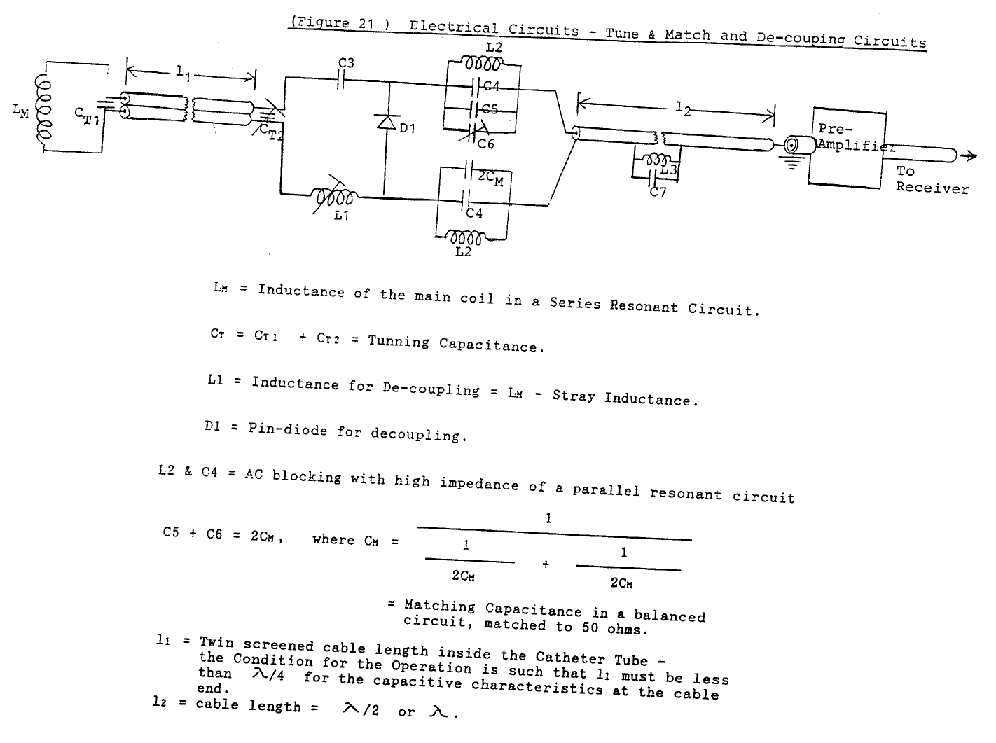

The tune & match and de-coupling circuits are illustrated in FIG. 21. L_{M} is the main coil inductance of the FERB receiving coil of this invention which is mounted onto the balloon of the catheter. Part of the tuning capactior, C_{T1} may be placed onto the plastic ring which is the tip end of the main coil. A smaller variable C_{T2} which may be controlled remotely is added on in parallel to C_{T1} at the other end of the twin screened cables outside the catheter assembly. The combined C_{T1} and C_{T2} give the overall C_{T} which is to tune the resonant circuit of the main coil, 11 is the cable length of the twin cables from the main coil to the tune and match circuit outside the catheter assembly. The loss in the cable length to keep at minimum; e.g. for RG174, the loss is 0.5 dB/meter. For an open-circuited line, if 11 is kept at less than λ/4, the input impedance will appear capacitive, C₃ is a large DC blocking capacitor. D₁ is the pin diode which is switched on by the reverse bias for the de-coupling (or de-tuning) purpose. L₁ plus some stray inductance is the inductance in the de-coupling circuit. It is equivalent to the inductance L_{M} of the main RF coil. As L_{M} may very from patient to patient, therefore L₁ is variable and remotely controlled. During the RF transmission, a reverse bias of −15V, is applied to switch on the pin diode, D₁. By shorting across it, the decoupling circuit of L₁ will cause a high impedance the tuning capacitor(s), C_{T}. An imperfect de-coupling will leave a residual in the main RF coil which will cause interference to the B₁ field. During the RF receiving mode, a normal +15V across D₁ switches off the pin-diode for the normal RF signal output to the pre-amplifier, and the into the receive of the system. L₂ and C₄ is an AC blocking circuit of a high impedance parallel resonant circuit, allowing only the DC to flow through it, A variable C₆ in parallel to C₅ provides half of the matching capacitance, 2C_{M} on the central lead part of the circuit. The other 2C_{M} is on the braid (or common) lead part of the circuit. The two 2C_{M} in series will provide the overall C_{M} for the matched RF( i.e. AC) output in a well balanced overall circuit. If the impedance across the tuning capacitance, C_{T} is higher than 50 ohms, then the added C_{M} will from a capacitance divider to step down the impedance across C_{T} to the required 50 ohms for the matching purpose. If it is less than ohms across C_{T}, a parallel resonant circuit will help to transform it upwards. The cable with a length 12 carries the output RF signal into the pre-amplifer and into the receive. In case of an imperfect matching, the cable length is best kept at either λ2, or λ for the unit transformation in order to minimize loss. If the λ2 cable length is still too long, then a lumped circuit may be added in to shorten the cable to provide the ‘combined λ2’ effect. In some cases, it may also be necessary to introduce an AC blocking via the L₃ and C₇ circuit to break up any possible earth loop for the RF. The may also help to optimize the overall performance. Again, all components used be strictly non-magnetic.

### LOADING OF THE MAIN COIL, SET-UP PHANTOM, AND THE MATCHING FOR THE 50 OHMS OUTPUT

When a RF coil is inserted into a patient, there will be an overall loading effect from both the inductive (or magnetic) loading and the capacitive loading. The overall in-vivo Quality Factor, Q, of the main coil will be loaded. Only the inductive loading will contribute to the MR signal for the imaging. The capacitive loading will shift the resonant frequency of the RF main coil. Both the inductive and the capacitive loadings will load the Q of the circuit. In order to optimize the coil performance, a careful set-up is required to tune and match the main coil to the in-vivo patient loading conditions. However, a saline (i.e. NaCl) solution in a phantom which may be a jar, or a fish tank may be used in place of the patient to simulate the loadings. Both the initial first order tune and match of the RF circuit to correct for both the shifted resonant frequency and to the in-vivo loaded Q may be carried out in a set-up phantom externally in a laboratory (i.e. in-vitro). The final second order tune and match, and in occasion, even the first order effect, may then be done while inside a patient. The will correct for the inductance change of the main coil and thus the tuning capacitance change in order to maintain the same resonant frequency, and to match to the appropriate lading conditions. The body loading will change from organ to organ, and from patient to patient. However, an automatic tune and match system will help to save time and improve the efficiency during the actual real time imaging operations. The design of the automatic tune and match system is outside the area of the claims.

The miniaturization of the ‘balloon/RF main coil’ set has its limit. The inductance loading on the coil set will need to be significant enough to overcome the loss in the electronic components and cables in order to provide a reasonable MR signal for the imaging, in some cases, to build the whole or a certain part of the tune and match circuit on board of the RF main coil may be required to overcome the losses in the cables.

### PRE-AMPLIFIER CIRCUIT

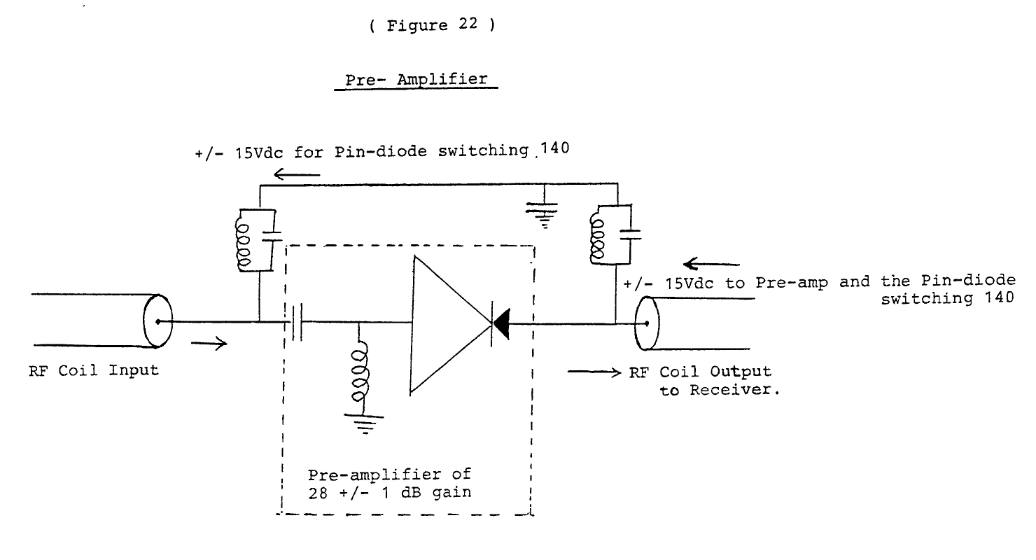

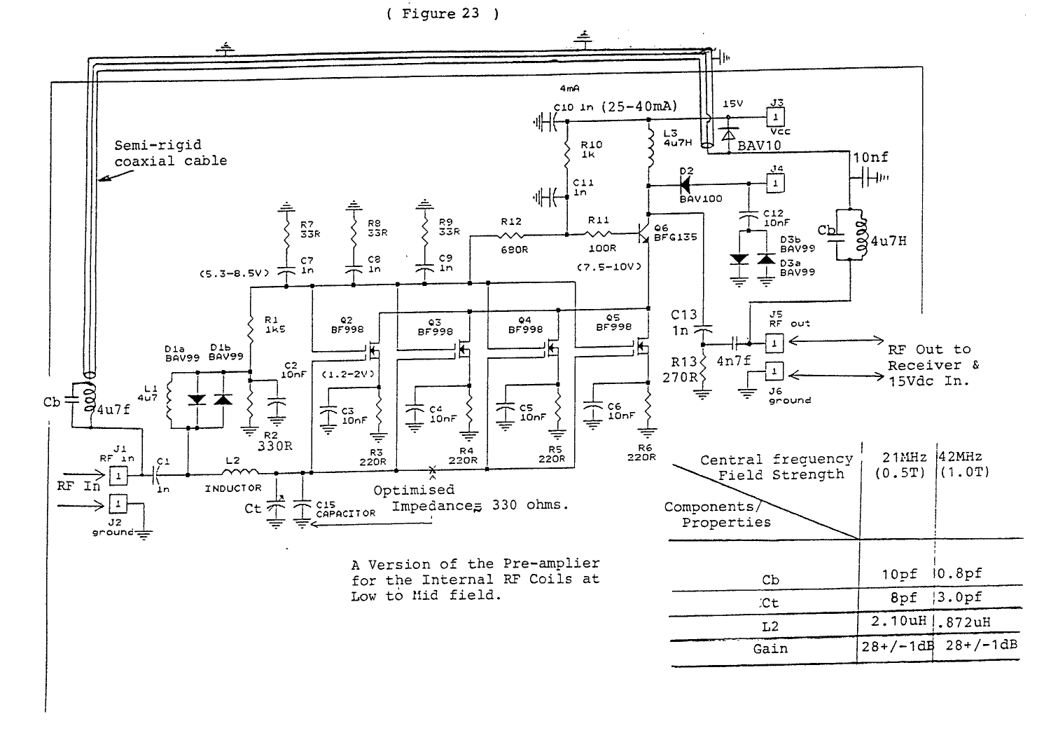

The pre-amplifier and the reversible 15V dc supply 140 to switch to switch the pin-diode (D₁ in FIG. 21) are illustrated in the schematic of FIG. 22. A low input impedance pre-amplifier for the 50 ohms source input does provide a good noise feature in the performance. There may be several options of pre-amplifier design. They are again outside the scope of this invention claims. However, for the illustration purposes, one version of the pre-amplifier for the 21 MHz (0.5T) to 42 MHz (1.0T) is shown un FIG. 23.

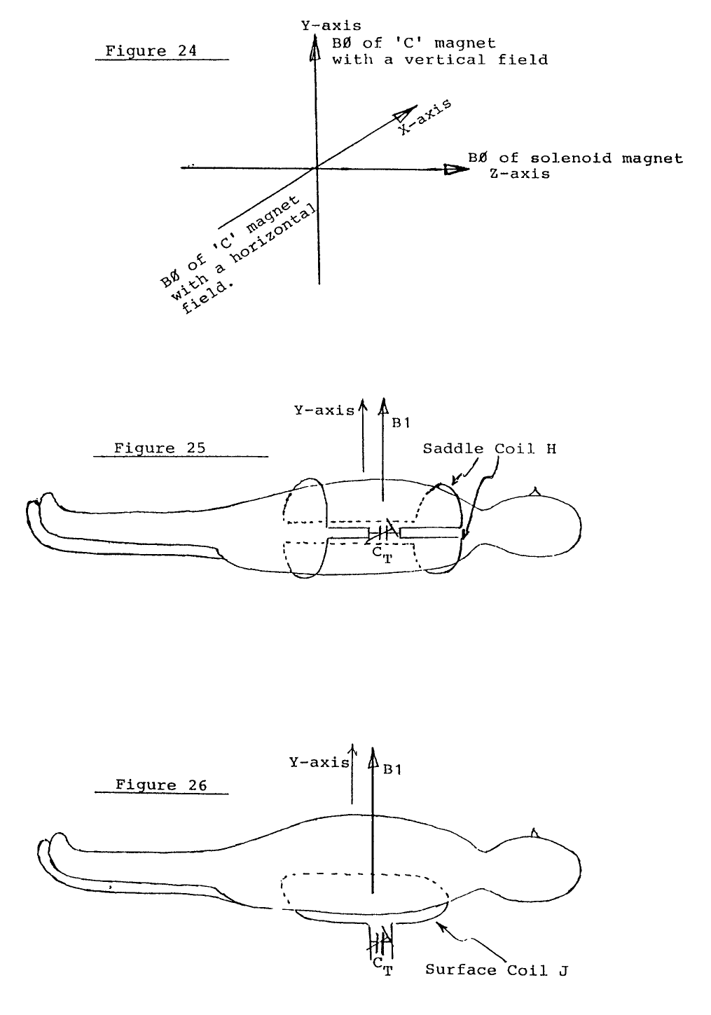

Following the paragraph of ‘magnet types’, the three type of magnet system may be further summarized as illustrated in FIG. 24, where their B₀ directions may be represented by the three axis in the Cartesian coordinates. The three types of magnet are further explained as follows:

The current solenoid magnet (FIG. 2) which is being used in most MR system, has the axial B₀ magnetic field through a plurality of annular driver magnetic coils. This type of magnet has the advantage of producing a uniform field up to a higher field strength of more than 2 teals when the super conducting driver magnetic coils are used. The disadvantages of this type of solenoid magnet are that—(a) there is the claustrophobia problem for a sick patient within the deep tunnel, (b) the patient inaccessibility implies that life-aide may not be easily administered to a sick patient, and (c) with magnet being the heart of an MR system and is the high cost item in an MR system, the solenoid magnet is especially costly to construct in comparison with the ‘C’ magnet.

The ‘C’ magnet MR system with a vertical B₀ magnetic field (FIG. 3) is also available in the current market. Due to the improved patient accessibility, the improved claustrophobia effect, and the lower cost of the magnet-hence the lower overall work cost price of the whole MR system, this system is already proven to be a good seller in the current world market. However, there are still a number of distinct disadvantages associated with this particular configuration, which are explained as follows:

(a) there is still the phobia of having a large and heavy object i.e. the upper magnet pole pressed close to the chest, and the fear of it collapsing on top of the patient,

(b) due to the closeness of the magnet pole to the patient chest, the space available for the life-aids administration is still quite restricted,

(c) the B1 RF field of the Saddle (body) Coil, H in FIG. 25, or Surface Coil J etc.. in FIG. 26 is parallel to the vertical B0 magnetic field, therefore no MR signal may received. The existing Body, Head, Surface and Internal Coils designed for the solenoid magnet MR system can no longer be adopted to be used in this system. Therefore, both the availability and the efficiency for the different type of RF coils and their designs are greatly reduced,

(d) the gravitational force on the pole mass above the patient reinforces the existing attraction force of the two poles causing extra mechanical stress and strain on the ‘C’ return arm. This will hinder the further increase in the magnetic field strength for the improvement in the image quality (i.e. signal to noise) and the applications in MR Spectroscopy. And that the vibrations from the activation of the gradient coils, if in synchronization with the ‘C’ arm property (i.e. the tuning fork phenomenon), may cause both the deterioration of the image performance in a lesser extent, but the total collapse of the mechanical structure in a more serious safety consideration.

The third type of magnet is the ‘C’ arm with a horizontal field. This type of magnet is not yet in existence. Therefore it is the main interest and the subject for the second part of this invention registration.

### A ‘C’ MAGNET HORIZONTAL FIELD MAGNETIC RESONANCE SYSTEM:

This invention relates to the method of generating a strong linear magnetic field extending over a relatively large distance which will have the specific applications in magnetic resonance imaging.

The invention of this ‘C’ magnet horizontal field magnetic resonance system will address and overcome all the disadvantages of the above two current existing systems of the solenoid magnet and the ‘C’ magnet with the vertical field.

The construction of this invention may be best illustrated by the step-by-step way:

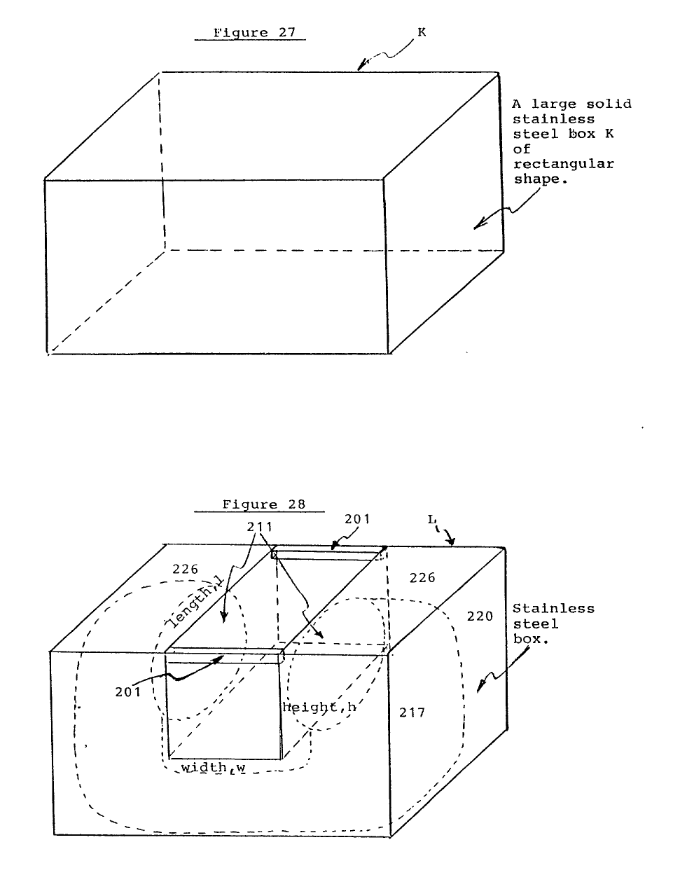

Firstly, we may construct a large stainless steel hollow box, K, of rectangular shape (FIG. 27). An elongated slot of dimensions of length 1, width w, and height h may be cut out in the middle section of the box with the open walls sealed up as indicated in FIG. 28. Supporting arms 201 are introduced to strengthen the mechanical structure. A ‘C’ magnet with the horizontal field may be built into the hollow space, or the dewar, of 226 ( FIGS. 28 & 29 ). Cryogens are filled into the rest of the space for the super conducting operation. The major components of this new ‘C’ magnet are:

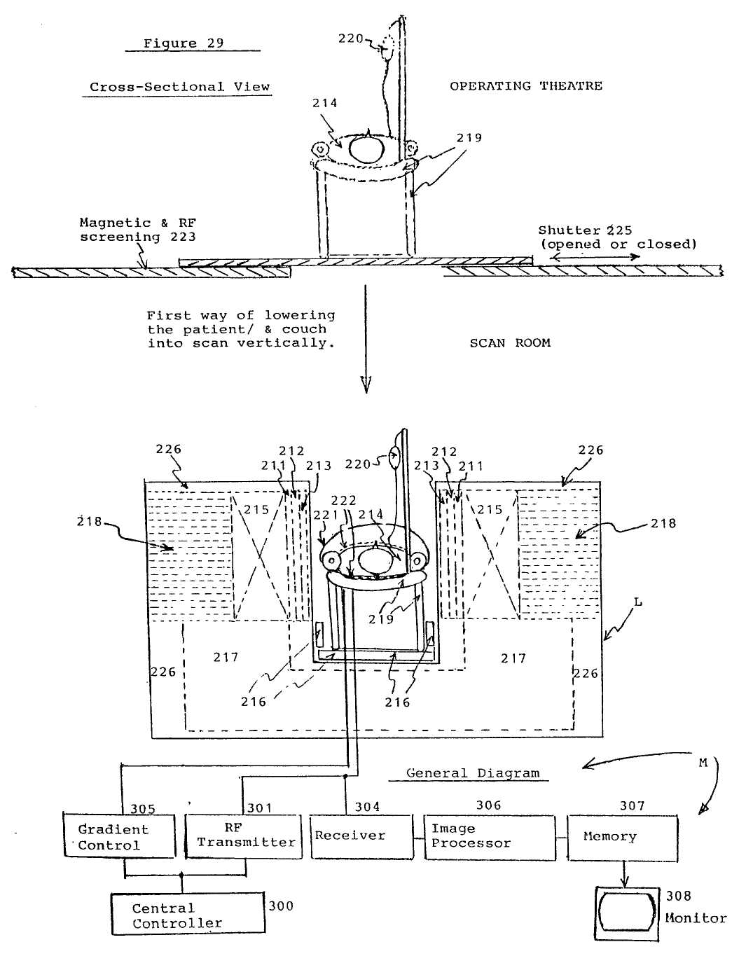

the pole faces 211 ( FIG. 29 ) and the iron return path 217. The patient 214 on a couch 219, who may be supported by life-aids 220, may be either lowered down, via a Shutter opening 225, into the elongated magnet gap from another room above such as the Operating Theatre (which is separated by the magnetic and RF screening 223);

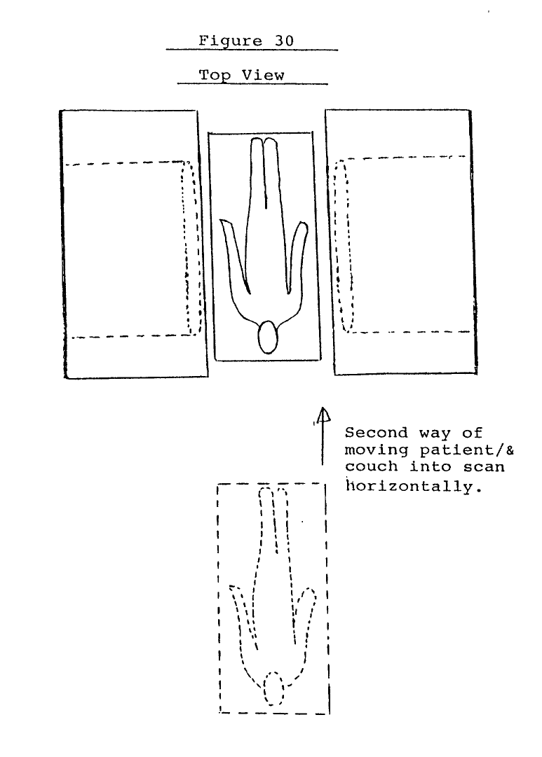

Or to be slotted into it horizontally such as that illustrated by the Top View of FIG. 30. The transmitter body 221 may be placed around the patient with the surface or other receiving coil(s) 222 placed on the patient for images. In FIG. 29, 211 are the laminated pole faces, and 212 are the on-the-pole-face active and passive shimming for the second order corrections for the field homogeneity/or uniformity. 213 are the gradient coils. 215 are the drivers. 217 is the return path for the magnetic flux. 216 are the active and passive shimming to correct for the asymmetry of the ‘C’ iron arm which would distort the field uniformity. Major first order field uniformity corrections may be achieved by behind-the-pole-face shimming:

by the stacked laminae 218 of electrical sheet steel having the ferromagnetic sheets sandwiched in for the passive shimming and by the electrical conductors for the active shimming. This first order behind-the-pole-face shimming is best described in U.S. Pat. No. 4,656,449, by J. R. Mallard and F. E. Neale. The overall system is illustrated by the General Diagram in FIG. 29:

The central controller 300 controls both the RF transmitter 301 and the gradient field control 305 to implement a pre-selected magnetic resonance imaging sequence. The electronic assembly M includes the RF transmission means 301 which selectively applies the radio frequency pulses to a transmit coil 221 to excite magnetic resonance of dipoles within the magnetic field. The electronic receiver 304 receives the magnetic resonance signals from the region of interest using a receiver coil(s) as the antenna. A gradient coil controller 305 applies pulses to the gradient field coils 213 (FIG. 29) to cause gradients across the gap magnetic field in field in order to encode the magnetic resonance signals. An image reconstruction means or the image processor 306 performs an inverse Fast Fourier Transform to reconstruct an image representation from the received magnetic resonance signals. The images obtained may be stored in the memory 307 and displayed on a monitor 308.

1) The basic mechanical and electrical designs of the flexible, expandable, and retractable balloon (FERB) RF receiving coil assembly to address the said key areas of interest.,

2) The said family of the various shapes, and sizes of the balloon, and the various types of coil assembly made of the flexible PCB mounted onto the said shapes of balloon for the various said applications when inserted into the said types of patient organs for said types of detections, and for addressing the said key areas of interest.,

3) The designs of the said rigid-rod form of the cervix RF receiving coil for the imaging of the cervix, areas/volume above the cervix, and areas/volume surrounding the vagina canal passage.,

4) The said designs of the disposable outer shell to be placed onto the above rigid-rod form of the cervix RF receiving coil and for any other rigid rod formers of any shape for the health and safety protections. This form of outer shell may also be used on the ultra-sound probes of any shapes.,

5) The balance electronic circuits for the tune & match, and the de-coupling purposes, and also for the various ways of optimization to enhance the imaging performances., and,

6) The phantom set-up to tune and match the electronic circuits according to the in-vivo patient loading of the quality factor, Q, of the RF main coil by both the inductive and capacitive loadings, and also to correct for the shift in the resonant (central) frequency of the RF main coil caused by the capacitive loading.

7) The logic of the overall ‘C’ magnet horizontal field MR system as described in the application text.,

8) The stainless steel rectangular box approach to construct the MR system as described in the application text.,

9) The above solid mechanical structure to provide a rigid framework to sustain the structure in order to eliminate any possible vibrations which may deteriorate the image performance and to cause the mechanical failure of the structure.,

10) The above mechanical structure and the cryogenic arrangements to provide higher field strength for the improvement of signal-to-noise in images, and the possible applications in MR Spectroscopy,

11) The above ‘open-space’ of the system in front of the patient may be used to eliminate claustrophobia effect and to provide two modes of operation in loading the patient on the couch by:
(a) that the patient/couch may be lowered down into the magnet air gap from above, or from another room above such as the Operating Theatre, and (b) that the patient/couch may be loaded in side way similar to most scanner systems such as CT and Solenoidal MR systems,

12) The That the ‘C’ magnet with the horizontal Bo field's vector direction orthogonal to the B1 RF field direction of the Receiving Coils such as the Body Saddle Coil, Head Solenoid Coil, Surface Coils, and Internal Coils of the Solenoidal MR system that a direct adaptation may be implemented, and,

13) The simplicity and therefore the low cost factors of the magnet and also the whole system.
